(19) United States
(12) Patent Application Publication
(10) Pub. No.: US 2018/0326882 A1
(43) Pub. Date: Nov. 15, 2018

(54) CABLE ASSEMBLY FOR VEHICLE SEAT HEADREST

(71) Applicant: CTC Acquisition Company LLC, Rockford, MI (US)

(72) Inventors: David Frederick Bach, Rockford, MI (US); James Walter Bach, Grand Rapids, MI (US); Christopher Gale Inman, Trufant, MI (US)

(21) Appl. No.: 15/977,506

(22) Filed: May 11, 2018

Related U.S. Application Data
(60) Provisional application No. 62/505,478, filed on May 12, 2017.

(51) Int. Cl. B60N 2/844; B60N 2/835; B60N 2/824

(52) U.S. Cl. CPC B60N 2/844; B60N 2/829; B60N 2/824; B60N 2/835

(57) ABSTRACT

A cable assembly for folding vehicle seats having a folding headrest that folds as the seat back is moved to a folded positon. A cable interconnects a headrest folding mechanism with a stationary component whereby movement of the seat back shifts the cable. The cable assembly includes first and second portions that are interconnected by an adjuster rod and a retainer. The adjuster rod and retainer permit interconnection of the first and second cable segments upon assembly of the headrest with the seat back in a manner that permits taking up slack in the cable assembly.

### CROSS-REFERENCE TO RELATED APPLICATION

This application claims benefit to U.S. Provisional Patent Application No. 62/505,478, filed on May 12, 2017, entitled “CABLE ASSEMBLY FOR VEHICLE SEAT HEADREST,” the entire contents of which is hereby incorporated by reference in its entirety.

### BACKGROUND OF THE INVENTION

Various types of folding vehicle seats have been developed. Known folding vehicle seats may include a folding headrest that folds as the seat back is rotated/lowered. The headrest may include a folding mechanism inside the headrest that is operably connected to a stationary lower portion of the seat by a cable. Forward/downward rotation of the seat back during the folding process causes the cable to shift under tension. This shifting of the cable releases the headrest folding mechanism, and the folding mechanism then causes the headrest to fold. The headrest folding mechanism may include a spring that folds the headrest when the mechanism is released by the cable.

### SUMMARY OF INVENTION

One aspect of the present disclosure is a method of installing a cable assembly to a vehicle seat wherein the vehicle seat includes a seat base and a seat back that folds relative to the seat base. When installed, the cable assembly operably interconnects a folding headrest to the seat base and causes the headrest to fold as the back is folded relative to the seat base. The method includes interconnecting a first end of a lower cable to the seat base. A retainer is releasably connected to the vehicle seat to temporarily restrict movement of the retainer relative to the vehicle seat. The lower cable slidably engages the retainer. The lower cable has a second end with a stop that is configured to engage the retainer and transmit force to the retainer when the lower cable is tensioned. After a cover is installed on the seat back, an end of a tubular headrest support is inserted through an upper structure of the back in a first direction, whereby an adjustment member disposed on the end of the tubular headrest support engages the retainer. The retainer and the adjustment member include first and second ratchet features, respectively, that permit movement of the adjustment member in the first direction relative to the retainer, but prevent movement of the adjustment member relative to the retainer in a second direction that is substantially opposite to the first direction. The adjustment member is connected to the upper cable such that the upper and lower cables are operably interconnected due to the interconnection of the retainer and the adjustment member. The method further includes interconnecting the upper cable to a releasable folding mechanism of the headrest. The retainer is disconnected from the vehicle's seat to permit movement of the retainer relative to the vehicle's seat, whereby movement of the seat back relative to the base shifts the upper and lower cables and releases the folding mechanism of the headrest. The ratchet features permit shortening of the cable assembly to take up slack resulting from dimensional tolerances (variations) in the components, but prevent increases in the overall length of the cable assembly.

Another aspect of the present invention is the cable assembly for vehicle seats having a headrest that folds as a folding back folds forward and downwardly relative to a seat base. The cable assembly includes a lower cable having a first end that is configured to be operably connected to a seat base. An upper cable has an upper end that is configured to be operably connected to a folding mechanism of a folding headrest. A connecting assembly interconnects a second end of the lower cable to a second end of the upper cable. The connecting assembly includes first and second connecters that are connected to the upper and lower cables, respectively, and ratchet features providing a one-way mechanical interconnection between the first and second connecters. The one-way mechanical interconnection permits an overall length of the cable assembly between the folding mechanism and the base to be reduced to take up slack in the cable assembly, but prevents an overall length of the cable assembly from increasing.

### BRIEF DESCRIPTION OF THE DRAWINGS

FIG. 1 is a partially fragmentary view of a vehicle seat having a folding seat back and folding headrest assembly;

FIG. 2 is an exploded perspective view of a cable assembly according to one aspect of the present disclosure;

FIG. 3 is an exploded perspective view of a portion of the cable assembly and headrest assembly;

FIG. 4 is a perspective view of a first portion of the cable assembly;

FIG. 4A is an enlarged fragmentary view of a portion of the adjuster rod of FIG. 4;

FIG. 5 is a perspective view of a second portion of the cable assembly;

FIG. 6 is an exploded perspective view of a junction box and clip;

FIG. 7 is partially fragmentary view of a portion of the cable assembly;

FIG. 8 is an exploded perspective view of the cable assembly during assembly;

FIG. 9 is a partially fragmentary exploded perspective view of a cable assembly according to another aspect of the present disclosure; and

FIG. 10 is a fragmentary perspective view of a portion of the cable assembly of FIG. 9.

### DETAILED DESCRIPTION

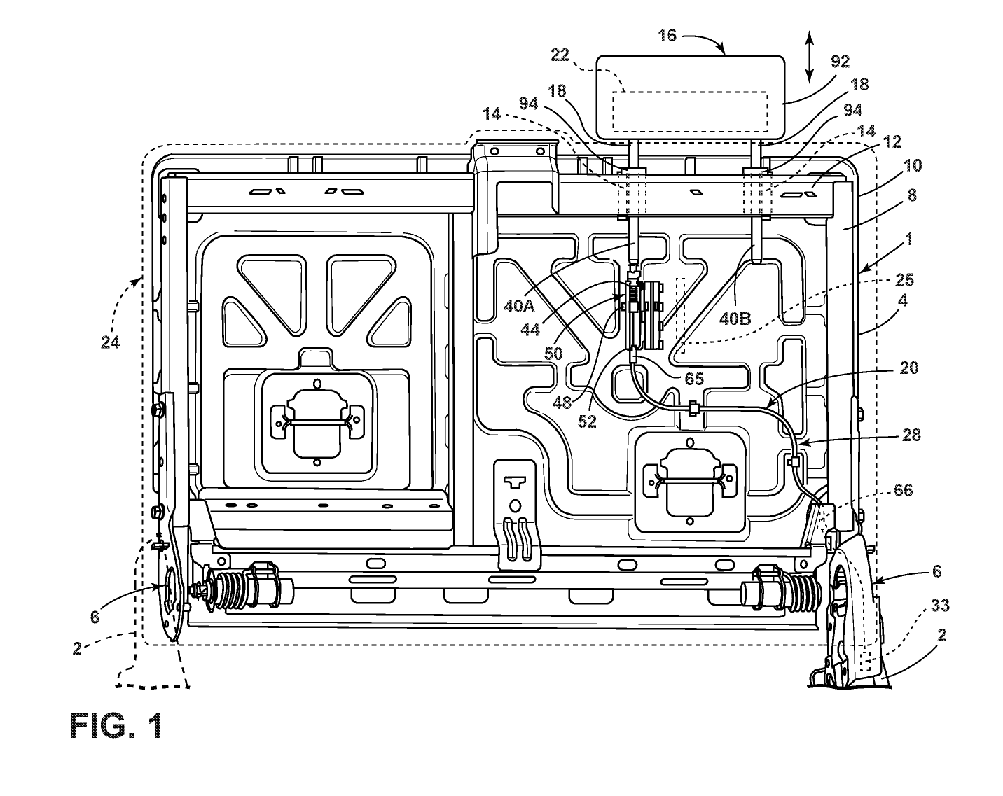

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a vehicle seat assembly 1 includes a base 2 that may be secured to a floor of a vehicle, and an upright seat back 4 that is rotatably interconnected to the base 2 by a pair of hinge mechanisms 6. The hinge mechanisms 6 permit the seat back 4 to rotate forwardly/downwardly to thereby fold the seat assembly 1. It will be understood that the vehicle seat assembly 1 may be utilized as a rear seat in an SUV or other such vehicle. The hinge mechanism 6 may comprise a suitable known hinge mechanism, such that a detailed description of the hinge mechanism 6 is not believed to be required.

The seat back 4 includes a frame structure 8 and a sheet-like pan structure 10. The frame structure 8 includes an upper cross member 12 having fittings or guide tubes 14. A headrest assembly 16 includes a pair of rods 18 that are slidably received in the fittings 14 to permit sliding insertion of rods 18 in fittings 14 during assembly. Stops 94 limit the range of downward movement of headrest assembly 16.

Headrest assembly 16 includes a spring-loaded folding mechanism 22 that is operably connected to the base 2 or other stationary structure by a cable assembly 20. In use, a user releases hinge mechanism 6, and folds seat back 4 by rotating seat back 4 forwardly and downwardly. Movement of seat back 4 shifts/tensions cable 20 to thereby release folding mechanism 22 of headrest assembly 16. The folding mechanism 22 may include a spring (not shown) that is preloaded when the headrest assembly 16 is in a non-folded (upright) configuration. Release of the folding mechanism 22 causes the headrest assembly 16 to fold (rotate forwardly) due to the spring force. The basic operation of headrest folding mechanism 22 is known to those skilled in the art.

When vehicle seat assembly 1 is fully assembled, a cover 24 extends over and covers the frame structure 8 and pan structure 10. The cover 24 also covers the cable assembly 20, such that access to cable assembly 20 is restricted. During the production process, it is desirable to install headrest assembly 16 after the cover 24 is installed. However, because the cable assembly 20 is covered by cover 24, access to cable assembly 20 is limited, making it difficult to connect the cable assembly 20 to the folding mechanism 22 in prior processes/designs. As discussed in more detail below, the present disclosure provides a unique cable assembly 20 and assembly process that alleviates drawbacks associated with prior cables and assembly techniques.

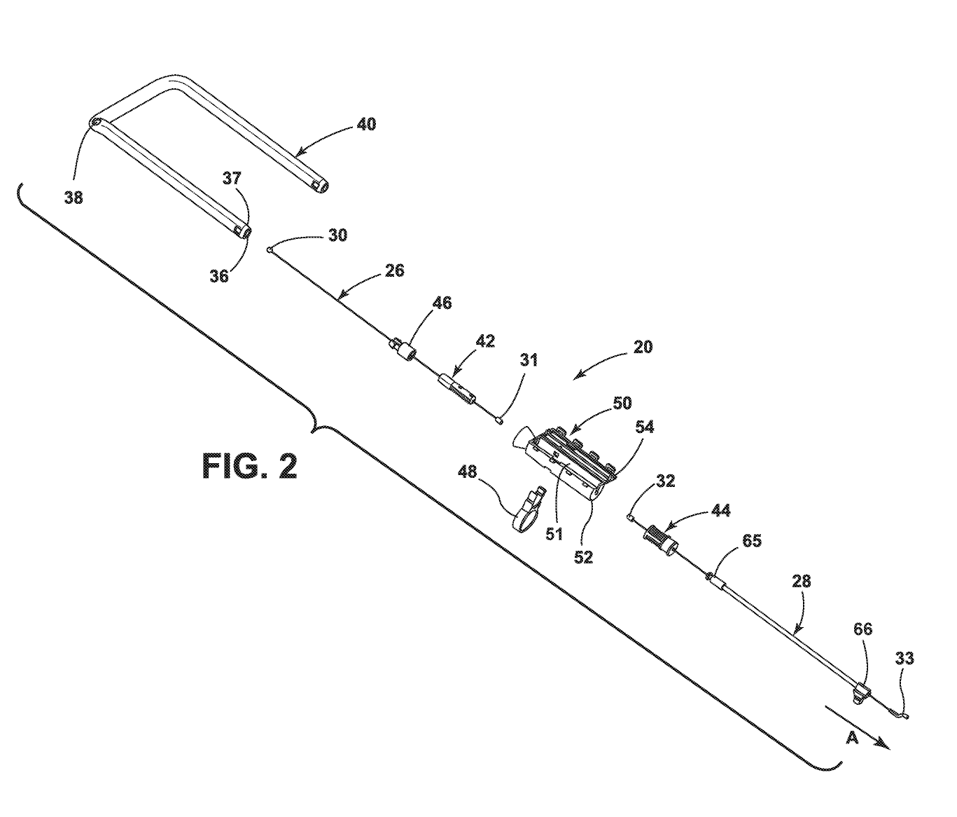

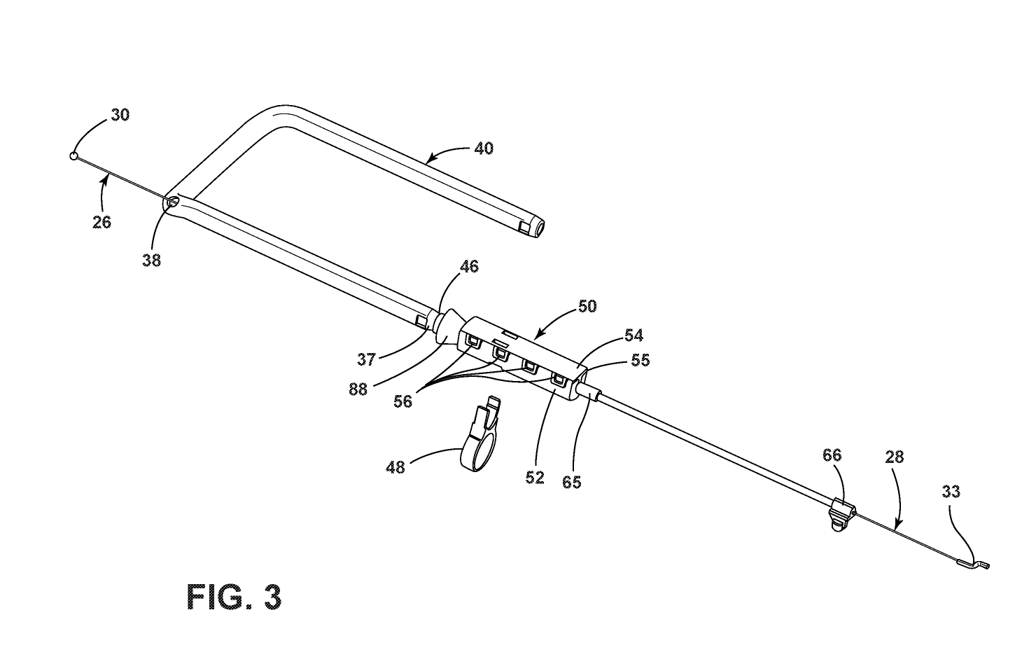

With further reference to FIG. 2, cable assembly 20 includes a first cable section 26 and a second cable section 28. First cable section 26 includes first and second stops or end fittings 30 and 31, respectively. Similarly, second cable section 28 includes end fittings 32 and 33. End fitting 30 of cable section 26 may comprise a conventional ball fitting or the like that is configured to operably connect first cable section 26 to a folding mechanism 22 in a known manner. Similarly, end fitting 33 of second cable section 28 is configured to operably connect second cable section 28 to a stationary component such that folding of seat back 4 generates a tension on cable section 28 in the direction of the arrow “A” in a known manner (FIG. 2). When assembled (FIG. 3), Cable 26 extends into bar 40 through opening 36 at end 37 of U-shaped bar 40 of headrest assembly 16, and cable 26 extends out through opening 38 of U-shaped bar 40.

Referring again to FIG. 2, an adjusting member such as adjuster rod 42 is slidably disposed on cable 26, and a retainer 44 is slidably disposed on cable section 28. As discussed in more detail below, when cable assembly 20 is assembled, the adjuster rod 42 is connected to the retainer 44 to thereby interconnect the first and second cable sections 26 and 28, respectively. Also, when assembled, an alignment fitting 46 is received in the opening 36 at end 37 of U-shaped bar 40 (FIG. 3) to retain adjuster rod 42, an alignment with portion 40a of bar 40 during assembly. During assembly, a clip 48 is used to temporarily retain the retainer 44 within a junction box 50 while the adjuster rod 42 is moved into engagement with retainer 44, and clip 48 is then removed to permit movement of retainer 44 within junction box 50.

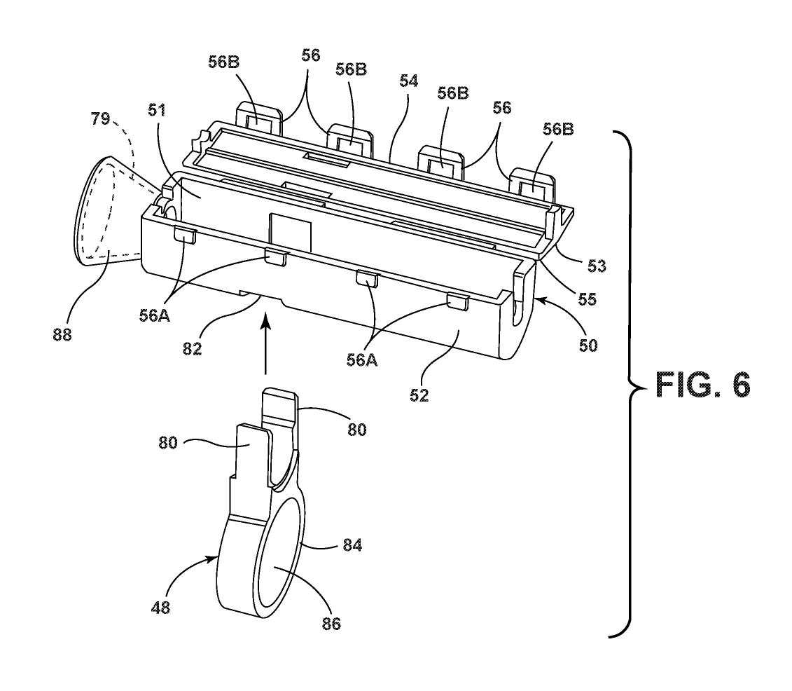

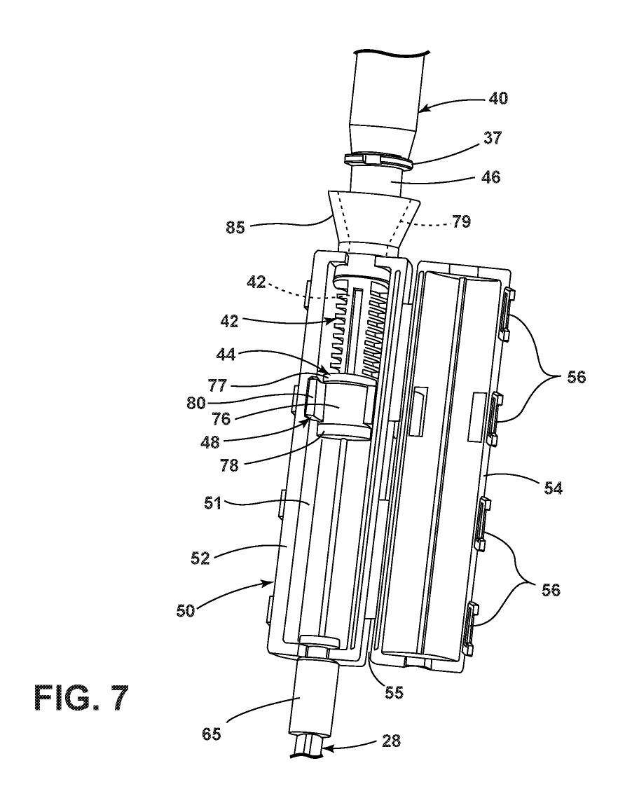

Referring to FIGS. 3 and 6, a support such as junction box 55 includes a base 52 and a cover 54 that is connected to the base 52 by a living hinge 55. When assembled, the cover 54 is closed, and snap-type retainers 56 with raised portions 56A that engage openings 56B to retain the cover 54 in the closed position to close off interior space 51 of junction box 50. Base 52 and cover 54 may be integrally molded from polymer or other suitable materials. It will be understood that the cover 54 is closed as shown in FIG. 3 when the cable assembly 20 is assembled. Nevertheless, the cover 54 is shown in an open position in some of the drawings (e.g. FIGS. 1 and 7) to show the adjuster rod 42, retainer 44, and other components that are disposed within the junction box 50.

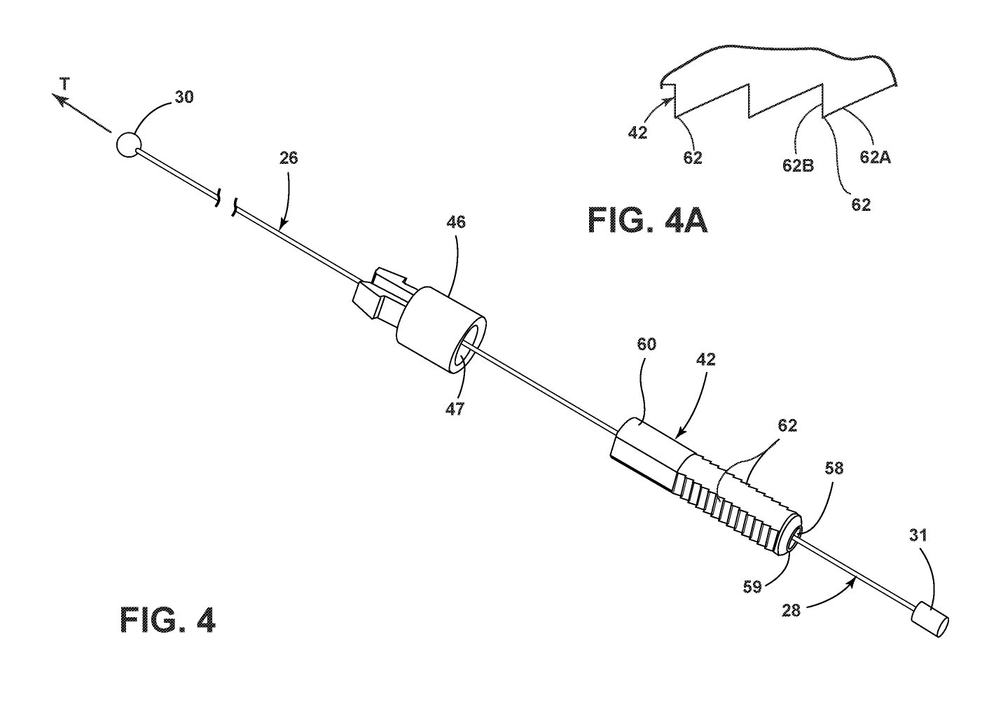

With further reference to FIGS. 4 and 4A, the adjuster rod 42 includes an opening or internal passageway 58 that slidably receives the cable 26. If a tension force “T” is applied to the end fitting 30 along the axis of cable 26, the end fitting 31 will engage (contact) end surface 59 of the adjuster rod 42 adjacent opening 58. The opening 58 has a dimension that is smaller than the dimension of the end fitting 31 such that the end fitting 31 cannot slide through adjuster rod 42. The adjuster rod 42 includes a generally cylindrical outer surface 60 and a plurality of raised ridges 62 arranged in rows on opposite sides of adjuster rod 42. As shown in FIG. 4A, raised ridges 62 form one-way barbs or ratchets. As discussed in more detail below, when cable assembly 20 is assembled, the raised ridges 62 of adjuster rod 42 engage retainer 44 to thereby interconnect adjuster rod 42 and retainer 44.

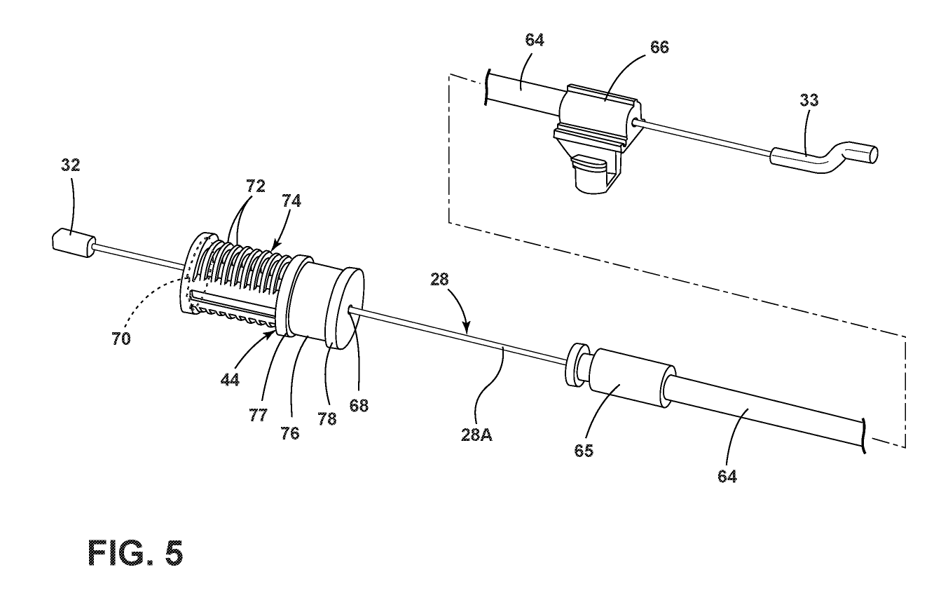

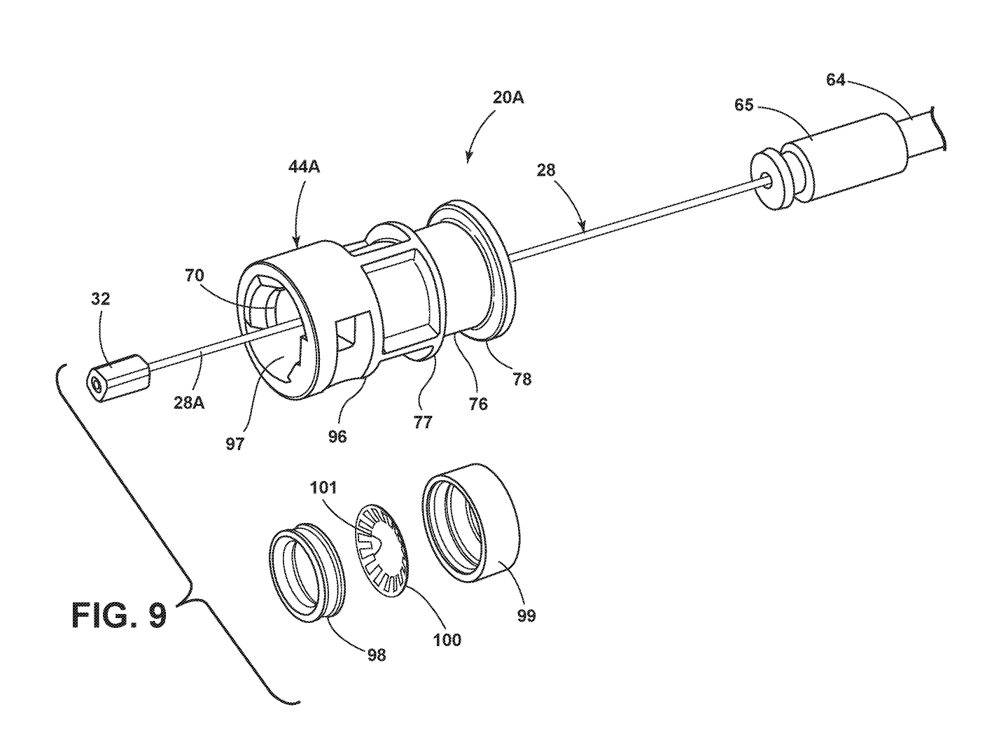

With further reference to FIG. 5, the second cable section 28 may include a sheath 64 that extends over an inner cable 28A. Fittings 65 and 66 are connected to the sheath 64. When assembled, the fitting 65 engages junction box 50 (see also FIG. 3), and fitting 66 engages a lower portion of seat back 4 adjacent hinge mechanism 6 (FIG. 1). Cable strand 28A extends through an opening or passageway 68 in retainer 44 such that retainer 44 is slidably disposed on the cable strand 28A. A larger portion 70 (see also FIG. 9) of opening 68 receives fitting 32. However, fitting 32 cannot pass through the opening 68, such that retainer 48 cannot slide off the inner strand 28A. A plurality of grooves or slots 72 are formed in a cylindrical portion 74 of retainer 44. When assembled, the raised ridges 62 of adjuster rod 42 (FIG. 4) are received in the slots 72 of retainer 44 to thereby interconnect adjuster rod 42 and retainer 44 in a one-way ratcheting manner, thereby interconnecting first cable section 26 with second cable section 28. The retainer 44 also includes an outer cylindrical portion 76 that is disposed between annular raised portions or ridges 77 and 78 to form an annular groove. During assembly, clip 48 engages cylindrical surface 76 to temporarily retain retainer 44 in junction box 50 as shown in FIG. 7.

With further reference to FIG. 6, removable clip 48 includes a pair of resilient arms 80 that may be inserted into an opening 82 in base 52 of junction box 50. The resilient arms 80 engage the cylindrical surface 76 of retainer 44 (FIG. 5) and prevent axial movement of retainer 55 within junction box 50. The clip 48 also includes a ring-like portion 84 having an opening 86. The ring-like portion 84 protrudes outwardly through opening 82 when resilient arms 80 are engaged with cylindrical surface 76 of retainer 44. The ring-like portion 84 provides a grip or connection portion that can be utilized to pull the clip 48 out of the opening 82, thereby disengaging the clip 48 from the cylindrical surface 76 of retainer 44. Housing 50 may include a tapered guide portion 88 having a conical tapered inner guide surface 79 that engages and guides end 37 of U-shaped bar 40 during assembly.

During assembly of the seat 1 (FIG. 1) the second cable section 28 is initially assembled with retainer 44 positioned in interior space 51 of junction box 50 with resilient arms 80 of clip 48 engaging retainer 44 (e.g. FIG. 7) to temporarily prevent movement of retainer 44 in junction box 50. Fitting 65 of second (lower) cable section 28 is connected to the base 52 of junction box 50. The junction box 50 is then secured to the seat back 4 prior to installation of headrest assembly 16 and cover 24, fitting 33 is connected to base 2 of seat assembly 1 and fitting 66 is connected to seat back 4. As discussed above, fittings 33 and 66 may comprise known designs. After the junction box 50 and second cable section 28 are installed to the seat back 4, the cover 24 (FIG. 1) is installed over the seat back 4.

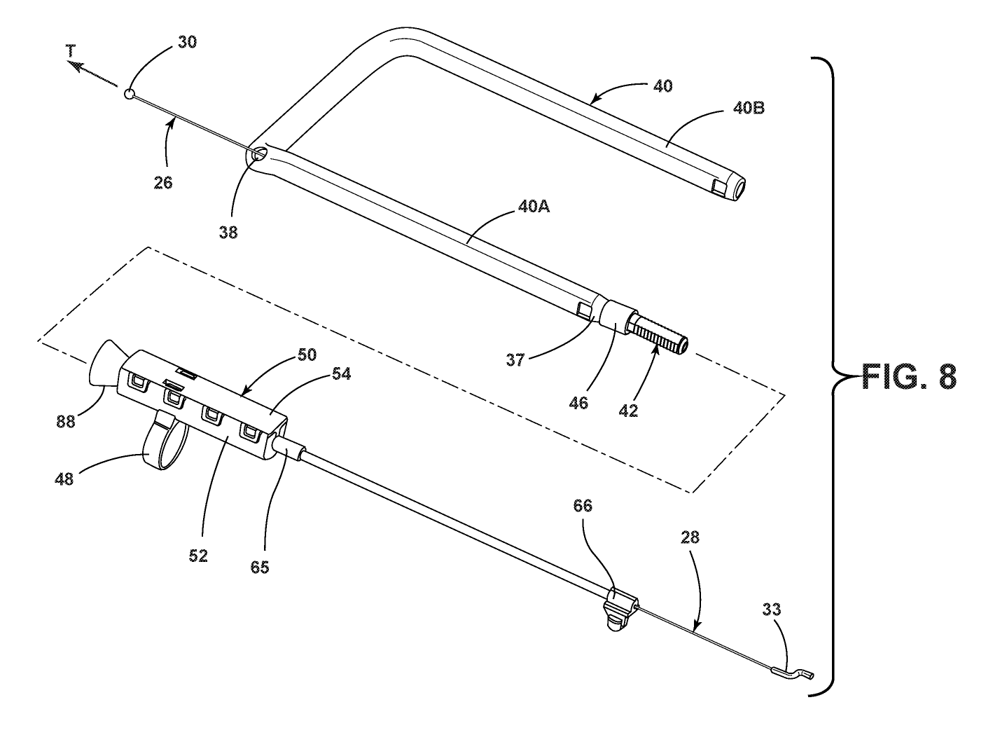

The headrest assembly 16 is then installed. Specifically, the first cable section 26 is connected to the headrest assembly 16 with the fitting 46 connected to end 37 of U-shaped bar 40 (FIGS. 3 and 7). As shown in FIG. 8, tension “T” may be placed on cable 26 to thereby shift cylindrical surface 60 of adjuster rod 42 into engagement with opening 47 (FIG. 4) of fitting 46, thereby retaining the adjuster rod 42 in alignment with linear portion 40A of U-shaped bar 40. The linear portions 40A and 40B of U-shaped bar 40 are then inserted into the fittings 14 (FIG. 1) of upper cross member 12 of frame structure 8 of seat back 4, thereby causing the adjuster rod 42 to slide into opening 90 of tapered guide portion 88 of junction box 50.

As the U-shaped bar 40 is shifted downwardly, the adjuster rod 42 is pushed into opening 70 engagement with retainer 44. The raised ridges 62 of adjuster rod 42 engage the slots 72 of retainer 44 in a one-way ratcheting manner, such that adjuster rod 42 slides into engagement with retainer 44 with a relatively low force. However, adjuster rod 42 cannot be pulled out of retainer 44 unless a very large force is applied. As shown in FIG. 4A, raised ridges 62 may include angled surfaces 62A and 62B such that ridges 62 form barb-like structures providing substantially one-way ratcheting engagement between adjuster rod 42 and retainer 44. As discussed above, the clip 48 temporarily retains retainer 44 in junction box 50. Thus, as adjuster rod 42 is pushed into engagement with retainer 44, the retainer 44 does not move within junction box 50.

As the U-shaped bar 40 is moved downwardly, the upper portion 92 (FIG. 1) of headrest assembly 16 contacts stops 94 of seat back 4, thereby preventing further downward movement of U-shaped bar 40. It will be understood that various types of stops may be utilized to limit downward movement of the U-shaped bar 40. In general, the stop is configured to ensure that no further downward movement of U-shaped bar 40 is possible when the U-shaped bar 40 is in the proper final position.

The clip 48 is then removed to permit movement of retainer 44 within junction box 50. A small access opening or slit 25 may be provided in cover 24 to permit removal of clip 48. After clip 48 is removed, a tension force on second cable portion 28 due to folding of seat back 4 will cause movement of cable section 26 due to the interconnection of adjuster rod 42 and retainer 44 to thereby release the folding mechanism 22 of headrest assembly 16.

In addition to permitting assembly of the headrest after installation of cover 24, the cable assembly 20 of the present disclosure also accounts for tolerances in the various components. Specifically, as discussed above, the upper portion 92 (FIG. 1) of headrest assembly 16 is shifted downwardly until a stop prevents further movement when the upper portion 92 is in the proper final position. Because the adjuster rod 42 can engage the retainer 44 at a variety of different positions, the engagement of adjuster rod 42 with retainer 44 during assembly automatically provides the proper cable length for the cable assembly 20, even if various tolerances (dimensional variations) in the components are present. Thus, the cable assembly 20 ensures that the upper portion 92 of headrest assembly 16 can be properly positioned against the stop 94, and the cable assembly 20 will not have any undesirable slack that could otherwise be caused by variations in the tolerances of the various components.

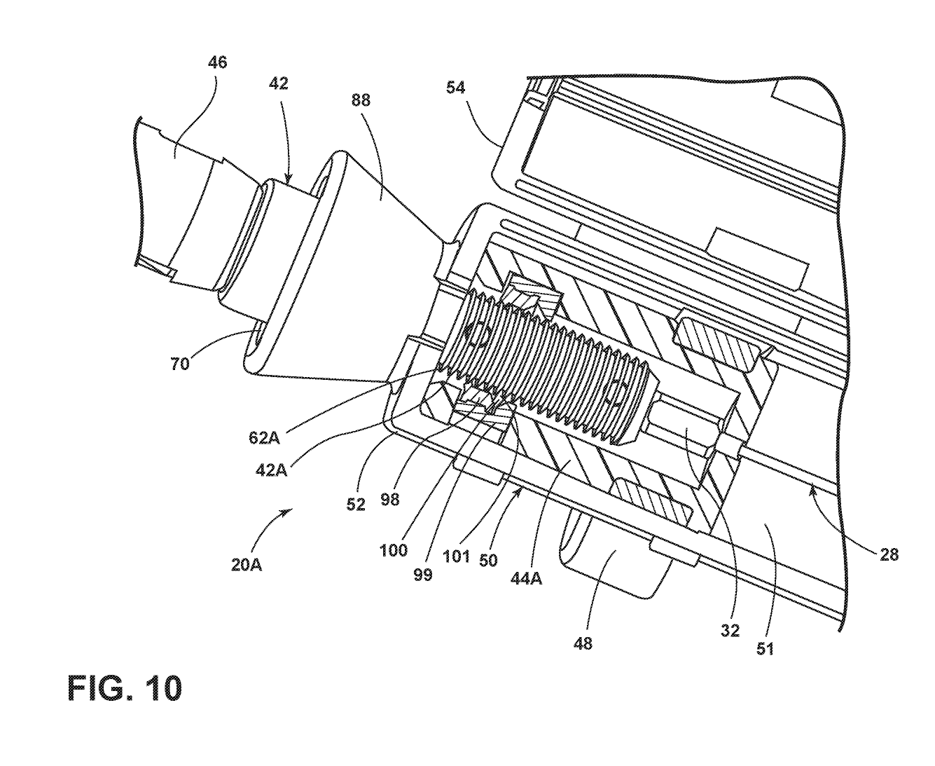

With further reference to FIGS. 9 and 10, a cable assembly 20A according to another aspect of the present disclosure includes a retainer assembly 44A including a retainer body 96 forming an opening 97. When assembled (FIG. 10) rings 98 and 99 retain a steel push nut 100 inside body 96 of retainer 44A. During assembly, adjuster rod 42A is inserted into the opening 97 of retainer 44A, thereby causing flexible arms 101 of push nut 100 to engage raised ridges 62A of adjuster rod 42A. The raised ridges or rings 62A may comprise tapered teeth forming one-way barbs (e.g. FIG. 4A) that permit insertion of rod 42A into retainer 44A, but prevent removal of adjuster rod 42A from retainer 44A. The cable assembly 20A of FIGS. 9 and 10 is assembled to vehicle seat assembly 1 in substantially the same manner as discussed above in connection with FIGS. 1-8.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. A method of installing a cable assembly to a vehicle seat having a base and a back that whereby the cable assembly, when installed, operably interconnects a folding headrest to the seat base and causes the headrest to fold as the back is folded relative to the base, the method comprising:
interconnecting a first end of a lower cable to the seat base;
releasably connecting a retainer to the vehicle seat to temporarily restrict movement of the retainer relative to the vehicle seat, wherein the lower cable slidably engages the retainer, the lower cable having a second end with a stop that is configured to engage the retainer and transmit force to the retainer when the lower cable is tensioned;
after a cover is installed on the seat back, inserting an end of a tubular headrest support and an upper cable disposed inside the tubular headrest support through an upper structure of the back in a first direction, whereby an adjustment member disposed on the end of the tubular headrest support engages the retainer, wherein the retainer and the adjustment member includes first and second ratchet features, respectively, that permit movement of the adjustment member in the first direction relative to the retainer, but prevent movement of the adjustment member relative to the retainer in a second direction that is substantially opposite the first direction, wherein the adjustment member is connected to the upper cable such that the upper and lower cables are operably interconnected due to the engagement of the adjustment member with the retainer;
interconnecting the upper cable to a releasable folding mechanism of the headrest; and
disconnecting the retainer from the vehicle seat to permit movement of the retainer relative to the vehicle seat, whereby movement of the seat back relative to the base shifts the upper and lower cables and releases the releasable folding mechanism of the headrest.

2. The method of claim 1, including:
connecting a junction support to the seat back; and wherein:
the retainer is releasably connected to the junction support by a clip having flexible arms.

3. The method of claim 2, wherein:
the retainer includes an annular groove; and
the flexible arms of the clip engage the annular groove.

4. The method of claim 3, wherein:
the clip is disengaged from the annular groove and removed through an opening in the cover.

5. The method of claim 1, wherein:
the retainer includes a passageway with a plurality of inwardly facing grooves;
the adjustment member includes at least one row of outwardly protruding teeth that engage the grooves to form a one-way ratchet connection.

6. The method of claim 5, wherein:
the adjustment member comprises a rod, and includes two rows of outwardly protruding teeth on opposite sides of the rods; and
causing both rows of outwardly protruding teeth to engage the grooves by inserting a portion of the adjustment member into the passageway of the retainer.

7. The method of claim 1, wherein:
the end of the tubular headrest support includes an opening;
the adjustment member comprises a rod;
inserting an alignment fitting into the opening; and
causing the adjustment member to engage the alignment fitting to retain the adjustment member in alignment with the tubular headrest support.

8. The method of claim 7, wherein:
the alignment fitting includes an opening;
inserting an end portion of the adjustment member into the opening of the alignment fitting.

9. The method of claim 1, wherein:
the retainer includes a body and a push nut secured to a first end of the body, the push nut including a plurality of inwardly extending flexible arms disposed about an opening and forming one-way barbs; and
inserting a portion of the adjustment member into the opening to flex the flexible arms and interconnect the retainer and the adjustment member.

10. A cable assembly for vehicle seats having a headrest that folds when a folding seat back folds relative to a seat base, the cable assembly comprising:
a lower cable having a first end that is configured to be operably connected to a seat base;
an upper cable having an upper end that is configured to be operably connected to a folding mechanism of a folding headrest;
a connecting assembly interconnecting a second end of the lower cable to a second end of the upper cable, the connecting assembly including first and second connectors connected to the upper and lower cables, respectively, and ratchet features providing a one-way interconnection between the first and second connectors that permits an overall length of the cable assembly between the folding mechanism and the base to be reduced to take up slack in the cable assembly, but prevents the overall length of the cable assembly from increasing.

11. The cable assembly of claim 10, wherein:
the first connector comprises a rod having at least one row of outwardly projecting teeth;
the second connector comprises a retainer including a passageway having a plurality of inwardly-facing grooves, and wherein;
a portion of the rod is disposed in the passageway of the retainer with the teeth engaging the grooves to form the one-way interconnection.

12. The cable assembly of claim 11, wherein:
the upper and lower cables include fittings disposed on opposite ends thereof;
the rod includes an opening therethrough, and the first cable extends through the opening through the rod in sliding engagement therewith;
the retainer includes an opening therethrough, and the second cable extends through the opening through the retainer in sliding engagement therewith, and wherein:
the fittings on the ends of the upper end lower cables limit movement of the rod and the retainer on the upper and lower cable, respectively, whereby lengthwise movement of the lower cable due to folding of the seat back causes lengthwise movement of the upper cable to release a folding mechanism of a folding headrest.
